(19) United States
(12) Patent Application Publication
(10) Pub. No.: US 2009/0114621 A1
(43) Pub. Date: May 7, 2009

(54) METHOD AND DEVICE FOR THE PLASMA TREATMENT OF MATERIALS

(76) Inventors: Primoz Eiselt, Graz (AT); Miran Mozetic, Ljubljana (SI); Uros Cvelbar, Idrija (SI)

Correspondence Address: Workman Nydegger;1000 Eagle Gate Tower, 60 East South Temple, Salt Lake City, UT, 84111, US

(21) Appl. No.: 12/278,099

(22) PCT Filed: Feb. 1, 2007
(86) PCT No.: PCT/AT07/00046

§ 371 Date: Dec. 23, 2008

(30) Foreign Application Priority Data
Feb. 2, 2006 (AT) A 159/2006

(51) Int. Cl. B44C 1/22; C23F 1/08

(52) U.S. Cl. 216/69; 216/67; 156/345.31

(57) ABSTRACT

The invention relates to a method and a device (1) for the treatment of materials, in particular continuous materials such as wires, rods, tubes, etc. The device comprises a heating chamber (3) for heating a supplied material (8) during its movement through the heating chamber (3) and a plasma reactor (5) arranged downstream of the heating chamber and comprising at least one discharge chamber (10) through which the material (8) is conveyable continuously and in which the material can be subjected to plasma treatment while moving therethrough.

The present invention relates to a method and a device for the treatment of materials, in particular continuous materials such as wires, rods, tubes, etc.

In many production processes, materials such as wires, rods, tubes, etc. are used. Those materials either are delivered as semifinished or final products and processed further in the production process or are manufactured directly in the course of a production process and processed further. A problem which almost always arises in the process is that those materials are covered with a layer of impurities and thus cannot be processed immediately. At least a native layer of oxide is present on the surface. More frequently, the materials are also contaminated with different organic and inorganic impurities. Organic impurities are often residues of oil or fat which has been applied during processing. Inorganic impurities include oxides as well as chlorides and sulfides. The thickness of inorganic impurities on surfaces depends on the environment in which the component parts have been stored as well as on the temperature. The higher the temperature, the thicker the layer of inorganic impurities. The layer of impurities on component parts should be removed prior to further processing in order to ensure a good processing quality.

For example, the basic material available in the form of steel rods must be pretreated in preparation for the drawing of steel wires, since the steel rods usually exhibit a layer of scale attributable to the manufacturing process on their surfaces. In particular, scaling is a side effect in the manufacture of steel rods which occurs after the casting and hot-rolling of the rod. The term “scaling” describes the oxidation of the surface of the steel rod, which can be divided into different chemical structures: FeO and FexOy (divided into a surface layer and layers which penetrate deeper). Such oxide layers have a significantly higher (ceramic-like) hardness than steel and thus cause extensive wear of the drawing die when the scaled steel rod is drawn through the drawing die.

Conventional methods of cleaning surfaces of metallic components include mechanical and chemical treatments. Mechanical cleaning is often effected by brushing or sandblasting, whereas chemical cleaning is effected by dipping the materials into a solution of chemicals, followed by rinsing with distilled water and subsequent drying. However, none of those methods can guarantee perfect cleanness of the materials, but a thin layer of impurities will still exist on the surface.

So far, it has also not been possible to get the problem of the descaling of materials under control at reasonable costs. The descaling methods employed up to now can be divided into two groups, namely batchwise descaling and in-line descaling.

For batchwise descaling, a batch of the material to be descaled, e.g., a wire coil, is introduced into a large bath filled with a mixture of acids and lyes. The material is left in the bath for several hours. As a result, the entire scale is indeed etched off, but there is the problem that the material will form a new oxide layer after being removed from the bath. In order to prevent this, the surface of the material must be passivated in a further processing step, which, however, will in turn require an additional processing step of activating the material after processing thereof, e.g., after it has been drawn through a drawing die, so that the material will again be moistenable by lubricants etc. Moreover, using the batchwise descaling method as described, it is not possible to remove rusty parts from the interior of the material (20 μm and more below the surface) with a reasonable effort. In order to completely remove corrosions from a material depth of 40 μm, for example, on a steel wire with a diameter of 6 mm by etching them off or removing them mechanically, material with a cross-sectional area of 0.75 mm² would have to be removed, which corresponds to a wire with a diameter of 0.7 mm or 2.7% of the material, respectively. With a price of 600 [symbol] per ton, which is customary in the market, that would produce additional costs of 16.2 [symbol] per ton. The costs of the descaling method itself amount to approx. 10 to 100 [symbol] per ton, depending on the wire dimensions (the larger the wire diameter, the cheaper). Because of those high costs and the large expenditure of time, this type of descaling is therefore not applied on an industrial scale.

In order to reduce costs and the expenditure of work and logistics, an in-line descaling method has thus been developed in which the material (steel wire) is moved continuously through a treatment plant and is thereby processed. This known descaling method comprises several production steps:

At first, a mechanical descaling of the fed steel wire is effected by bending and twisting the steel wire, whereby FeO and FexOy will fall from the surface of the steel wire. By this measure, a substantial part of the scale can indeed be removed, but a hard black residual scale layer will remain which must be removed by all means before the wire is drawn.

Therefore, the wire is treated further by chemical processes or mechanical brushing in a second step. However, also this cleaning step is unable to remove the entire scale, but scale spots will still remain on the wire surface, which will result in an increased lubricant requirement during subsequent processing.

Prior to the drawing of the steel wire, a primer (soap carrier) is applied to the surface of the steel wire in order to achieve good adhesion between the material and a lubricant which is to be applied to the material surface prior to the drawing process. For most applications, the wire must be heated in order to accelerate phosphatization or a borax treatment and to facilitate the drawing process. Those treatments constitute an activation of the surface of the material.

In a fourth step, the wire is greased in order to be able to draw the wire more easily through the drawing die. Na or Ca stearates are usually used for greasing the wire. Since, as described above, residual scale still sticks to the material surface, a significantly larger amount of lubricant must be applied than would otherwise be required.

The present invention is based on the object of providing a material treatment method and a material treatment device which avoid the disadvantages of the prior art. In particular, the invention is supposed to provide a method and a device for cleaning, especially for descaling, materials, which does not only act on the surface of the material but also has a penetrative effect and which, furthermore, is feasible on an industrial scale at very low costs. Despite the penetrative effect during the material treatment, the invention should not be associated with the removal of substantial amounts of material.

The present invention solves the problem that has been posed by means of a method for the treatment of materials, in particular continuous materials such as wires, rods, tubes, etc., having the characterizing features of claim 1, as well as by means of a material treatment device having the characterizing features of claim 11. Advantageous embodiments of the invention are set forth in the dependent claims.

The invention is characterized in that materials, in particular continuous materials such as wires, rods, tubes, etc., particularly such made of steel, are conveyed through a heating chamber and are heated therein and subsequently are conveyed through a plasma reactor comprising at least one discharge chamber and are subjected therein to a plasma treatment. The material is thus treated in an in-line fashion, i.e., in a continuous motion. When the invention is used for descaling the material, a large part of the scale located thereon is caused to flake off due to the heating of the material, the remaining part of the scale is subsequently removed in the discharge chamber.

The present invention is excellently suited for descaling materials, wherein descaling can be performed in a very inexpensive but yet completely satisfactory manner. Due to the improved descaling of the basic material, dwell times of up to 95% can be achieved in wire drawing plants, compared to a maximum of 70%, which is achievable today. Since by the method according to the invention also the number of processing steps is reduced in comparison to the prior art, a substantial reduction in production costs can be achieved. Furthermore, drawing dies etc. are subject to less wear. The present invention also solves the problem of removing rust from the interior of the steel rods, without a significant loss of material occurring in the process.

For the heating of the material, it is provided in embodiments of the invention that the heating chamber comprises a resistance heating or a flame burner or an inductive heating, a capacitively coupled HF discharge, or a laser, or a light heating device or a plasma generation device. The material should be heated to at least 100° C. so that a substantial part of the scale falls off already in the heating chamber and the reduction of the surface of the material can occur more rapidly in the subsequent discharge chamber and, consequently, a smaller gas consumption can be achieved in the discharge chamber.

It has turned out to be advantageous if a gas atmosphere of hydrogen or hydrogen mixed with a noble gas prevails in the heating chamber, since such a gas atmosphere is preferred also for the discharge chamber and thus a common gas atmosphere generating means can be provided. In addition, via a hydrogen atmosphere in the heating chamber, it is ensured that no oxygen can enter into the discharge chamber, which would be harmful there.

In preferred embodiments of the invention, the discharges are generated in the discharge chamber of the plasma reactor by an inductive RF-discharge generating device or a microwave discharge generating device.

Furthermore, it is preferred that the pressure of the plasma treatment atmosphere in the discharge chamber is adjustable to between 1 and 100 mbar. Under those conditions, a concentration of hydrogen radicals in the plasma treatment atmosphere is adjustable to at least 10²⁰ m⁻³, which enables the removal of rust from the interior of wires, rods and the like without any substantial loss of material. Said effect is improved further if a flow of hydrogen radicals toward the surface of the material to be treated is adjusted to at least 10²³ m⁻² s⁻¹ in the discharge chamber. It is provided that the radicals are neutral or positively charged hydrogen atoms.

In order to prevent a recombination of H₂ radicals from occurring, it is provided in one embodiment of the invention that the at least one gas discharge chamber is delimited by walls which consist of a material or are coated with a material on the surfaces facing the gas discharge chamber which has a low recombination coefficient for the assembly of the gas atoms into molecules or radicals, respectively, with the material preferably being a glass such as, e.g., silica glass or a fluorinated polymer such as, e.g., PTFE.

A further reduction of the recombination of radicals can be achieved if the walls delimiting the gas discharge chamber are cooled, with cooling preferably being effected down to a wall temperature of below 60° C.

In order to prevent that dirt particles removed from the material in the heating chamber or O₂ atoms having entered the heating chamber along with the material reach the gas discharge chamber, in one advanced embodiment of the invention, a separation stage is provided between the heating chamber and the gas discharge chamber of the plasma reactor, which separation stage decouples the gas atmospheres in the heating chamber and in the gas discharge chamber from each other. As an additional measure for preventing a contamination of the gas discharge chamber by particles from the heating chamber, the pressure in the heating chamber can be adjusted lower than in the gas discharge chamber.

The invention is now illustrated in further detail based on an exemplary embodiment, with reference to the drawings.

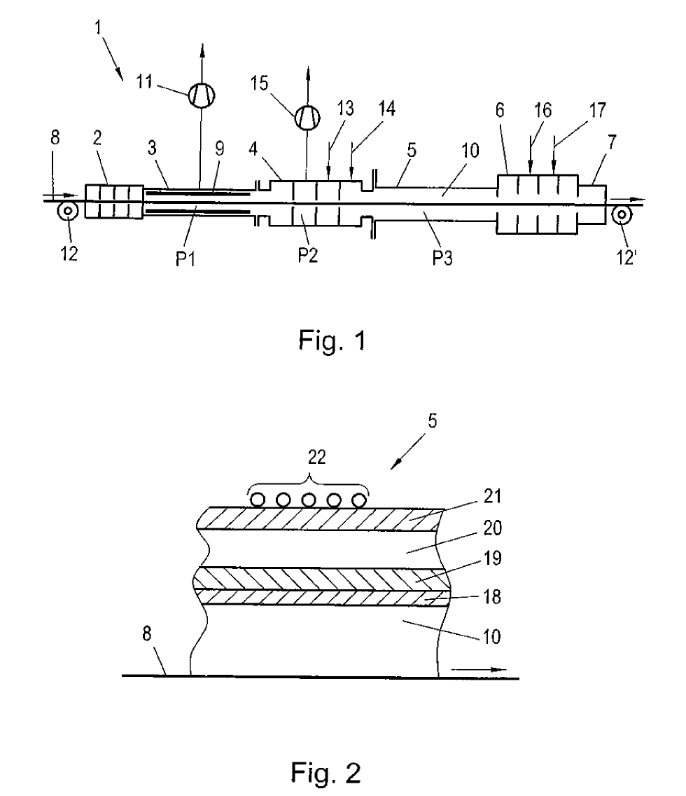

FIG. 1 shows a schematic illustration of a material treatment device according to the invention.

FIG. 2 shows a schematic longitudinal section of the plasma reactor of the material treatment device according to the invention.

In FIG. 1, an embodiment of a device 1 according to the invention for the treatment of materials, in particular continuous materials 8 such as wires, rods, tubes, etc., is schematically illustrated. The continuous material is conveyed through a lock 2 into a heating chamber 3, where it is heated to at least 100° C. by a heating device 9 while moving through the heating chamber 4 in order to cause contaminations such as scale located on the surface of the material 8 to flake off for the most part as a result of heating. A pressure P1 of from 0.1 to 10 mbar, which is produced by a vacuum pump 11, prevails in the heating chamber 3. In said exemplary embodiment, the heating chamber 8 exhibits a coaxial geometry, wherein the heating device 9 is designed as a plasma heating which comprises an external electrode functioning as an anode and being arranged in the heating chamber 8 as a coating of the continuous material. The continuous material 8 forms an internal electrode by being applied to ground potential via electroconductive rolls 12, 12′, thus functioning as a cathode. By applying a direct-current voltage, a DC gas discharge is produced between the electrodes and a plasma is thereby generated which exhibits ion densities higher than 10⁻¹⁷ m⁻³, whereby an extensive ion bombardment is obtained with a discharge voltage of several kV, which ion bombardment causes a strong surface heating on the continuous material 8. Temperature gradients higher than 100 K/mm can thereby be achieved across the cross-section of the continuous material. Alternative embodiments of the heating device comprise a resistance heating, a flame burner, an inductive heating, a laser, a capacitively coupled HF discharge, or a light heating device. The atmosphere in the heating chamber 3 is suitably adjusted as a gas atmosphere of hydrogen or hydrogen mixed with a noble gas, with said gas atmosphere being produced by passing gas through the separation stage 4 or the gas supply being effected via separate hydrogen or noble gas supply means, respectively, which are not depicted in the drawing.

The heating chamber 3 is adjacent to a separation stage 4 which serves for decoupling the heating chamber 3 from a plasma reactor 5 connected to the other side of the separation stage 4. The separation stage 4 is a lock which is provided with a gas feed line 13 for an inert gas and optionally with a further gas feed line 14 for a noble gas. The pressure P2 in the separation stage 4 is adjusted by a vacuum pump 15 such that it is higher than the pressure P1 in the heating chamber 3 so that gas can optionally flow from the separation stage 4 into the heating chamber 3, but not the other way round.

After having passed the separation stage 4, the prepurified material 8 heated in the heating chamber 3 reaches a discharge chamber 10 of the plasma reactor 5, where it is subjected to plasma treatment in order to remove the remaining contamination existing on the surface as well as in the interior of the continuous material 8. One embodiment of the plasma reactor and its mode of operation will be illustrated below in more detail on the basis of FIG. 2. After the plasma treatment, the continuous material 8 leaves the discharge chamber 10 of the plasma reactor through a combined gas supply/lock system 6 and reaches a cooling stage 7, where it is cooled down to temperatures below 100° C. and, subsequently, is conveyed into the surrounding atmosphere (air) and optionally is processed further there. The gas supply/lock system 6 has a gas supply 16 for hydrogen and a further gas supply 17 for a noble gas such as, e.g., argon. Due to the separate gas supplies, the composition of the gas atmosphere in the discharge chamber 10 as well as the pressure P3 prevailing therein can be regulated. The gas atmosphere preferably has a composition of 90-99% hydrogen and 10-1% argon. Pressure P3 should exceed the pressure P2 in the separation stage so that no backflow of gas and particles from the separation stage and from the upstream heating chamber can occur. Preferably, the pressure P3 is adjusted to 1-100 mbar.

FIG. 2 shows a schematic longitudinal section through the discharge chamber 10 of the plasma reactor 5. The discharge chamber 10 is constructed as a cylindrical vessel in the longitudinal axis of which or parallel thereto one or several continuous materials 8 to be cleaned are passed through. As an alternative to the cylindrical design, the discharge chamber 10 can also be designed as an elongate quadrangular or polygonal pipe. Viewed from the inside to the outside, the discharge chamber 10 is delimited by an interior wall 18 which is designed as a coating of the inner surface of a hollow cylindrical centre wall 19. The centre wall 19 is in turn surrounded by a hollow cylindrical external wall 21, with the inside diameter of the external wall 21 being chosen such that a hollow space 20 is provided between the outer surface of the centre wall 19 and the inner surface of the external wall 21, through which hollow space a cooling medium (e.g. water) flows in order to provide for sufficient cooling of the interior wall 18 and the centre wall 19, thereby preventing or at least reducing the recombination of radicals in the discharge chamber 10. It is intended to adjust the wall temperature to below 60° C. Furthermore, the interior wall 18 is manufactured from a material which has a low recombination coefficient for the assembly of the gas atoms into molecules or radicals, respectively. Those materials with low recombination coefficients usually have a smooth surface and can be different glass types or polymers such as, e.g., silica glass or fluorinated polymers such as, e.g., polytetrafluoroethylene. Further materials which are usable are ceramics and thermoplastics. In the discharge chamber, the plasma is generated such that a low kinetic energy of the gas particles is ensured, whereby a surface contamination by atomization is prevented. It should be mentioned that the centre wall 19 and the interior wall 18 may be designed as a single wall.

A coil 22 is wound around the external wall 21, which coil comprises approx. 5-15 windings and is charged with RF current from a high frequency generator, which is not illustrated, wherein the frequency of the RF current should amount to at least 2 MHz, but preferably amounts to at least 13 MHz, e.g., approx. 27 MHz. In this manner, inductively coupled discharges are produced in the discharge chamber 10 and a chemical plasma is generated (in contrast to ionic plasma in the heating chamber 3 and in devices according to the prior art). Unlike ionic plasma, chemical plasma does not involve the risk of hydrogen embrittlement and/or a chemical change (e.g., martensite formation) of the surface of the continuous material.

The concentration of hydrogen radicals in the plasma treatment atmosphere of the discharge chamber 10 is adjusted to at least 10²⁰ m⁻³. Furthermore, the flow of hydrogen radicals toward the surface of the material to be treated is adjusted to at least 10²³ m⁻² s⁻¹. The radicals are neutral or positively charged hydrogen atoms.

Inorganic impurities (mainly oxides such as rust) can be removed from the surface of the continuous material 8 as well as from the interior of the continuous material via the plasma treatment atmosphere of hydrogen or a mixture of hydrogen and a noble gas such as argon, which prevails in the discharge chamber 10. Hydrogen radicals produced in the discharge come into correlation with inorganic surface impurities and reduce them to water and other simple molecules such as HCl, H2S, HF etc., which are desorbed from the surface and pumped off. After the hydrogen plasma treatment, the surface is virtually free from any impurities. It has turned out to be advantageous if the plasma treatment atmosphere in the discharge chamber is a mixture of hydrogen and argon at a ratio of 95:5, which allows a very high concentration of hydrogen radicals in the plasma. The speed at which hydrogen radicals are formed in the gaseous plasma containing hydrogen depends on the capacity of the discharge source.

A particular aspect of the present invention is that, as a result of the specific conditions, no or only a small bombardment of the surface with high-energy ions will take place during the treatment, which proves to be particularly advantageous.

An essential feature of the invention is that the material treatment device 1 is a so-called in-line device, which means that the material 8 is conveyed continuously through the device, for example, by being unwound from a coil or a bundle. The material treatment device 1 according to the invention can also be designed as a multiline device, to which several continuous materials 8 to be treated are supplied in parallel.

1. A method for the treatment of materials, in particular continuous materials such as wires, rods, tubes, etc., comprising:
heating the material while moving through a treatment device and subsequently is subjected to plasma treatment.

2. A method according to claim 1, wherein the material is heated by Joule heating, flame, inductive heating, capacitively coupled HF discharge, laser, light or plasma.

3. A method according to claim 1, wherein the material is heated to at least 100° C.

4. A method according to claim 1, wherein the material is heated in an atmosphere of hydrogen or hydrogen mixed with a noble gas.

5. A method according to claim 1, wherein the plasma treatment occurs in a plasma treatment atmosphere of hydrogen or hydrogen mixed with a noble gas.

6. A method according to claim 1, wherein, during the plasma treatment, discharges are produced by means of an inductive RF discharge or microwave discharge.

7. A method according to claim 5, wherein the pressure in the plasma treatment atmosphere is adjusted to between 1 and 100 mbar.

8. A method according to claim 5, wherein a concentration of hydrogen radicals in the plasma treatment atmosphere is adjusted to at least 10²⁰ m⁻³.

9. A method according to claim 8, wherein a flow of hydrogen radicals toward the surface of the material to be treated is adjusted to at least 10²³ m⁻² s⁻¹.

10. A method according to claim 8, wherein the radicals are neutral or positively charged hydrogen atoms.

11. A device for the treatment of materials, in particular continuous materials such as wires, rods, tubes, etc., comprising:
a heating chamber for heating a supplied material during its movement through the heating chamber; and
a plasma reactor arranged downstream of the heating chamber and having at least one discharge chamber through which the material is conveyable continuously and in which the material can be subjected to plasma treatment while moving therethrough.

12. A device according to claim 11, wherein the heating chamber comprises a heating device such as a resistance heating, a flame burner, an inductive heating, a capacitively coupled HF discharge, a laser, a light heating device or a plasma generation device.

13. A device according to claim 11, wherein the heating chamber comprises a device for supplying hydrogen and optionally a noble gas.

14. A device according to claim 11, wherein the plasma reactor comprises a device for adjusting a plasma treatment atmosphere of hydrogen or hydrogen mixed with a noble gas in the at least one discharge chamber.

15. A device according to claim 11, wherein the plasma reactor comprises an inductive RF-discharge generating device or a microwave discharge generating device.

16. A device according to claim 14, wherein the pressure of the plasma treatment atmosphere in the discharge chamber is adjustable to between 1 and 100 mbar.

17. A device according to any of claims 14, wherein a concentration of hydrogen radicals in the plasma treatment atmosphere is adjustable to at least 10²⁰ m⁻³.

18. A device according to claim 17, wherein a flow of hydrogen radicals toward the surface of the material to be treated is adjustable to at least 10²³ m⁻² s⁻¹ in the discharge chamber.

19. A device according to claim 17, wherein the radicals are neutral or positively charged hydrogen atoms.

20. A device according to claim 11, wherein the at least one gas discharge chamber is delimited by walls which consist of a material or are coated with a material on the surfaces facing the gas discharge chamber which has a low recombination coefficient for the assembly of the gas atoms into molecules or radicals, respectively, with the material preferably being a glass such as silica glass or a fluorinated polymer such as PTFE.

21. A device according to claim 17, wherein the walls delimiting the gas discharge chamber are configured to be cooled, with cooling preferably being effected down to a wall temperature of below 60° C.

22. A device according to claim 11, wherein a separation stage is provided between the heating chamber (3) and the gas discharge chamber of the plasma reactor, which separation stage decouples the gas atmospheres in the heating chamber and in the gas discharge chamber from each other.

23. A device according to claim 11, wherein the pressure in the heating chamber is adjusted lower than the pressure in the gas discharge chamber.
